(19) United States
(12) Patent Application Publication
(10) Pub. No.: US 2025/0372829 A1
(43) Pub. Date: Dec. 4, 2025

(54) ENERGY STORAGE SYSTEM INCLUDING SUBMODULES HAVING STRUCTURAL INTERCONNECT BOARDS

(71) Applicant: Fluence Energy, LLC, Arlington, VA (US)

(72) Inventors: Kathryn Corine Streng Callahan, Golden, CO (US); Jordan David Petrie, Neenah, WI (US)

(73) Assignee: Fluence Energy, LLC, Arlington, VA (US)

(21) Appl. No.: 19/221,858

(22) Filed: May 29, 2025

Related U.S. Application Data
(60) Provisional application No. 63/654,565, filed on May 31, 2024.

(51) Int. Cl. H01M 50/519; H01M 10/42; H01M 50/507; H01M 50/528; H01M 50/548

(52) U.S. Cl. CPC H01M 50/519; H01M 10/425; H01M 50/507; H01M 50/528; H01M 50/548

(57) ABSTRACT

An energy storage enclosure includes a battery pack, a plurality of battery modules disposed within the battery pack, a plurality of battery submodules disposed within each of the plurality of battery modules, and a plurality of battery cells disposed within each of the plurality of battery submodules. Each battery cell includes structural interconnect board (ICB) assemblies disposed on opposing sides of the battery cell. Each of the structural ICB assemblies includes a carrier having a main portion that extends along one of the opposing sides of the battery cell, a first end portion that extends perpendicularly from a first end of the main portion along a top surface of the battery cell, and a second end portion that extends perpendicularly from a second end of the main portion along a bottom end of the battery cell.

### CROSS REFERENCE TO RELATED APPLICATION

This application claims the benefit of, and right of priority to, U.S. Provisional Patent Application No. 63/654,565, filed May 31, 2024, and entitled “ENERGY STORAGE SYSTEM INCLUDING SUBMODULES HAVING STRUCTURAL INTERCONNECT BOARDS,” the contents of which are expressly incorporated by reference as if fully set herein.

### INTRODUCTION

The concepts described herein relate generally to energy storage systems, and more specifically, to modular energy storage systems including battery modules with submodules that have structural interconnect boards (ICBs).

Modular energy storage systems include multiple individual energy storage enclosures interconnected to provide varied levels of storage capacity. Energy storage systems can be used to store additional power produced by an external power source during periods of reduced demand and provide additional power to external power sources during periods of increased demand.

Each individual energy storage enclosure includes multiple battery modules containing multiple submodules. Each battery submodule module includes multiple individual battery cells disposed adjacent to one another. Cell interconnect board (ICB) assemblies, which are disposed on opposing sides of each individual battery cell, provide sensing and bussing between adjacent battery cells.

The ICB assemblies between the adjacent battery cells are fragile and, as such, limit the number of individual battery cells that can be interconnected adjacent to one another within a submodule. This, in turn, limits the length of the submodule, which subsequently limits the overall storage capacity of each battery module, battery pack, and energy storage enclosure.

As such, it would be advantageous to provide a cell interconnect board assembly that is more robust.

### SUMMARY

In view of the above discussion, it is useful to develop an energy storage system including battery submodules having structural cell interconnect board (ICB) assemblies that add stiffness to the battery cell stack, allowing for longer submodules and/or cell stacks, which, in turn, increases the storage capacity of each battery submodule, allowing for more energy dense battery modules.

The concepts disclosed herein relate to an energy storage system that includes battery modules having structural ICB assemblies. Each structural ICB assembly includes a carrier that wraps around the edges of each individual battery cell, which may add stiffness to the battery cell, and/or cell stack, and incorporate structural support with sensing and bussing.

An energy storage enclosure according to the present disclosure may include a battery pack, a plurality of battery modules disposed within the battery pack, a plurality of battery submodules disposed within each of the plurality of battery modules, and a plurality of battery cells disposed within each of the plurality of battery submodules.

Each of the plurality of battery cells may include structural interconnect board (ICB) assemblies disposed on opposing sides of the battery cell. Each of the structural ICB assemblies may include a carrier having a main portion that extends along one of the opposing sides of the battery cell, a first end portion that extends perpendicularly from a first end of the main portion along a top surface of the battery cell, and a second end portion that extends perpendicularly from a second end of the main portion along a bottom end of the battery cell.

According to one aspect of the disclosure, the main portions of the structural ICB assemblies may be disposed adjacent to the opposing sides of the battery cell.

Each of the plurality of battery submodules may be adjacent to another of the plurality of battery submodules, and the structural ICB assemblies from adjacent battery submodules may be configured to connect the adjacent battery submodules to one another.

The connection between the structural ICB assemblies of the adjacent submodules may include an I-beam configuration.

According to one aspect of the disclosure, channels may be formed between the adjacent battery submodules when the structural ICB assemblies of the adjacent battery submodules are connected to one another.

Each of the plurality of battery cells may include a cell tab extending outward from the opposing sides of the battery cell, and wherein the structural ICB assemblies are disposed on the opposing sides of the battery cell. Each cell tab may include one of a positive terminal and a negative terminal.

Adhesive strips may be disposed underneath the structural ICB assembly to provide additional stiffness. The adhesive strips may be between the structural ICB assemblies and the battery cell.

According to one aspect of the disclosure, at least a subset of the cell tabs is attached to busbars. The subset of the cell tabs may be attached to the busbars via welding.

A modular energy storage system is also disclosed. The modular energy storage system may include at least two energy storage enclosures coupled to one another, a power conversion module coupled to an external power source and the at least two energy storage enclosures.

Each of the at least two energy storage enclosures may include a battery pack, a plurality of battery modules disposed within the battery pack, a plurality of submodules disposed within each of the plurality of battery modules, and a plurality of cells disposed within each of the battery submodules.

According to one aspect of the disclosure, each battery cell may include structural interconnect board (ICB) assemblies disposed on opposing sides of the battery cell.

Each of the structural ICB assemblies may include a carrier having a main portion that extends along one of the opposing sides of the battery cell, a first end portion that extends perpendicularly from a first end of the main portion along a top surface of the battery cell, and a second end portion that extends perpendicularly from a second end of the main portion along a bottom end of the battery cell.

A battery module for an energy storage system is also disclosed. The battery module may include a plurality of battery submodules arranged within the battery module. A plurality of battery cells may be arranged within each of the plurality of battery submodules.

Each of the plurality of battery cells may include structural interconnect board (ICB) assemblies disposed on opposing sides of the battery cell. Each of the structural ICB assemblies may include a carrier having a main portion that extends along one of the opposing sides of the battery cell, a first end portion that extends perpendicularly from a first end of the main portion along a top surface of the battery cell, and a second end portion that extends perpendicularly from a second end of the main portion along a bottom end of the battery cell.

According to one aspect of the disclosure, the main portions of the structural ICB assemblies may be disposed adjacent to the opposing sides of the battery cell.

Each of the plurality of battery submodules may be adjacent to another of the plurality of battery submodules, and the structural ICB assemblies from adjacent battery submodules may be configured to connect the adjacent battery submodules to one another.

The connection between the structural ICB assemblies of the adjacent submodules may include an I-beam configuration.

According to one aspect of the disclosure, channels may be formed between the adjacent battery submodules when the structural ICB assemblies of the adjacent battery submodules are connected to one another.

Each of the plurality of battery cells may include a cell tab extending outward from the opposing sides of the battery cell, and wherein the structural ICB assemblies are disposed on the opposing sides of the battery cell. Each cell tab may include one of a positive terminal and a negative terminal.

Adhesive strips may be disposed underneath the structural ICB assembly to provide additional stiffness. The adhesive strips may be between the structural ICB assemblies and the battery cell.

According to one aspect of the disclosure, at least a subset of the cell tabs is attached to busbars. The subset of the cell tabs may be attached to the busbars via welding.

By providing structural ICB assemblies, stiffness of the battery cell stack can be increased, which may allow for longer submodules and/or cell stacks to be utilized. In turn, storage capacity of each battery submodule may be increased, allowing for more energy dense battery modules.

By providing structural ICB assemblies including carriers that wrap around the edges of each individual battery cell, stiffness of the cell stack may be increased resulting in increased structural support. Sensing and bussing may be incorporated with the increased structural support, which may reduce component complexity and assembly time.

By utilizing the structural ICB assemblies to connect battery submodules to one another in an I-beam configuration, channels for gases may be created to assist in controlling the flow of cell off-gassing.

The incorporation of sensing and bussing with increased structural support may be used to optimize the cell to cold plate gap by reducing component complexity.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 schematically illustrates an energy storage enclosure including a battery pack, in accordance with the disclosure.

FIG. 3 schematically illustrates an exploded view of a battery module in accordance with one aspect of the disclosure.

FIG. 4 schematically illustrates a cross-sectional front view of battery cell, in accordance with one aspect of the disclosure.

FIG. 5 schematically illustrates a cross-sectional front view of two battery cells including structural interconnect board assemblies connected in an I-beam configuration, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

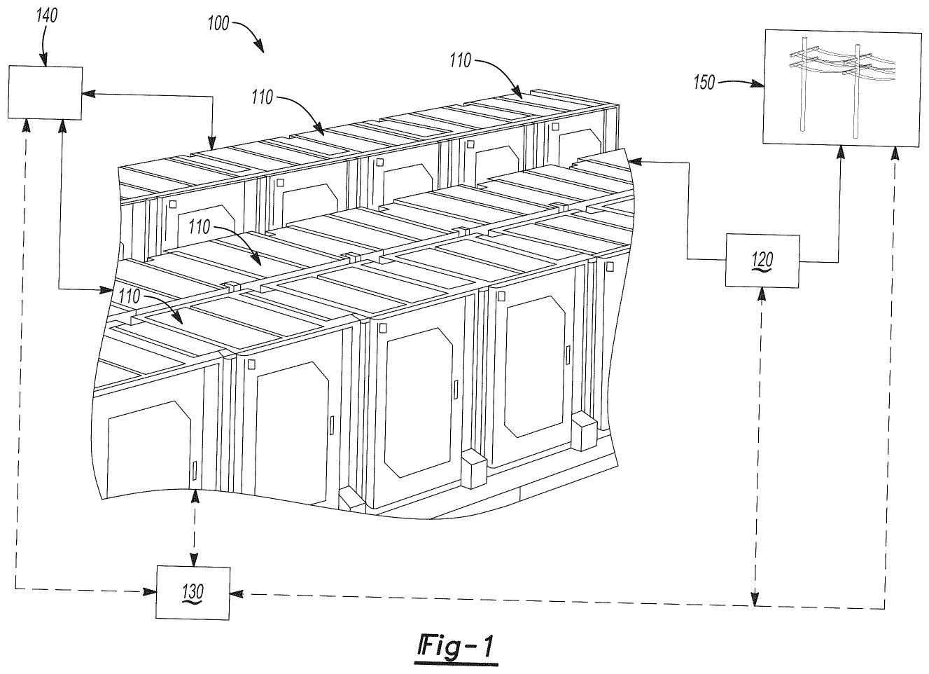

Referring to the drawings, wherein like reference numbers refer to the same or like components in the several Figures, FIG. 1 schematically illustrates an isometric view of an energy storage system 100 including a plurality of energy storage enclosures 110. The energy storage system 100 includes the plurality of energy storage enclosures 110, a power conversion module 120, a controller 130, an external cooling system 140, and an external power source 150.

The plurality of energy storage enclosures 110 are coupled to one another electrically, and collectively coupled to the power conversion module 120, the controller 130, the external cooling system 140, and the external power source 150. The plurality of energy storage enclosures 110, individually and collectively, are operable to store alternating current (AC) power delivered from the external power source 150 as direct current (DC) power, for example but not limited to when the demand for power from the external power source 150 is lower that the external power source 150 is operable to generate, and/or to provide DC power to the external power source 150, for example but not limited to, when the demand for power is higher than the external power source 150 is operable to generate. It should be appreciated that the plurality of energy storage enclosures 110 may be coupled to one another not only electrically, but also mechanically, and/or fluidly.

To facilitate the conversion of AC power to DC power and DC power to AC power, the power conversion module 120 is configured to standardize power input and output between the plurality of energy storage nodes 110 and the external power source 150. The power conversion module 120 may include, for example but not limited to, a converter configured to convert AC power to DC power, and/or DC power to AC power.

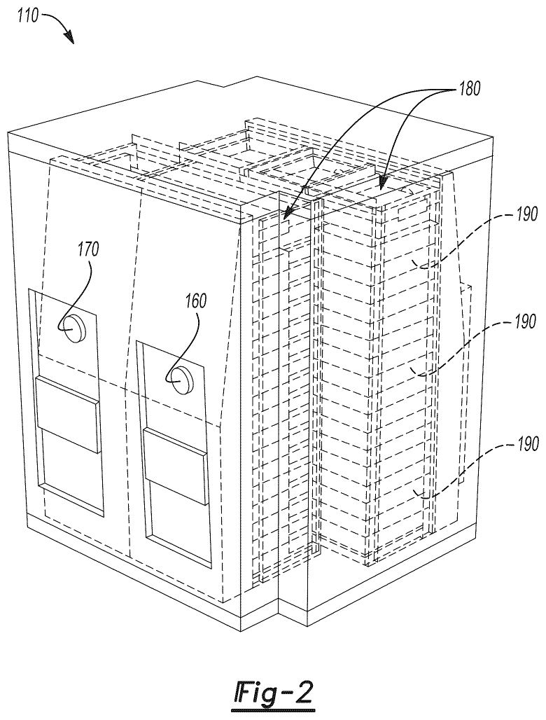

The external cooling system 140 is coupled to the plurality of energy storage enclosures 110, and the controller 130. The external cooling system is configured to provide coolant at a first temperature T₁ to the plurality of energy storage units 110 through at least one input port 160 and receive coolant from the plurality of energy storage units at a second temperature T₂ from at least output port 170 (FIG. 2), such that T₁ is lower than T₂.

The external cooling system 140 may include, for example but not limited to, a heat exchanging system having a pump, a condenser, a heat exchange, and a sump. It should be appreciated that the at least one input port 160 and the at least one output port 170 may include more than one input port 160 and/or one output port 170, and each of which may be disposed in one or more of the plurality of energy storage units 110.

The external power source 150 is coupled to the plurality of energy storage units 110. The external power source 150 is operable to provide AC power converted to DC power to the plurality of energy storage units 110 to be stored as DC power, and to receive AC power converted from DC power from the plurality of energy storage units 110, as discussed above.

The controller 130 is in communication with the plurality of energy storage units 110, the power conversion module 120, the external cooling system 140, and the external power source 150, and is configured to control the aforementioned plurality of energy storage units 110, the power conversion module 120, the external cooling system 140, and their communication with the external power source 150.

The term “controller” and related terms such as microcontroller, control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

As schematically illustrated in FIG. 2, the energy storage enclosure 100 includes a battery pack 180, and a plurality of battery modules 190 disposed within the battery pack 180.

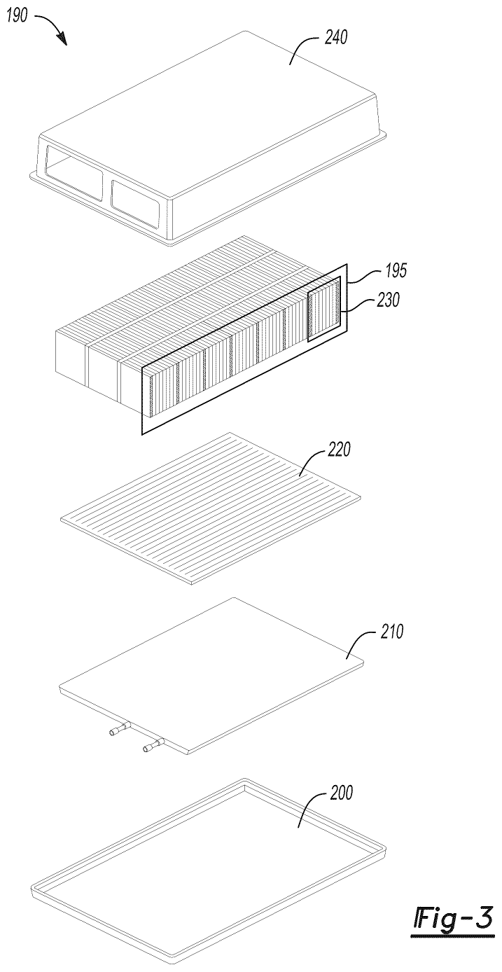

An exploded view of one of the plurality of battery modules 190 is schematically illustrated in FIG. 3. Each of the plurality of battery modules 190 includes a bottom plate 200, a cooling plate 210, a thermal interface layer 220, a plurality of battery submodules 195 including a plurality of battery cells 230 disposed adjacent to one another, and a battery module enclosure 240.

The plurality of battery submodules 195 are disposed within the battery module 190, and a subset of the plurality of battery cells 230 are disposed within each of the battery submodules 195.

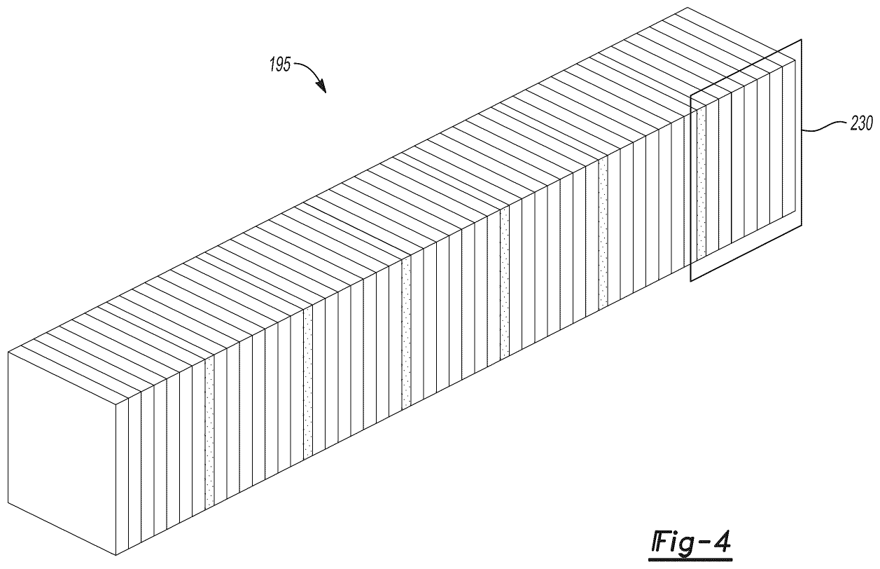

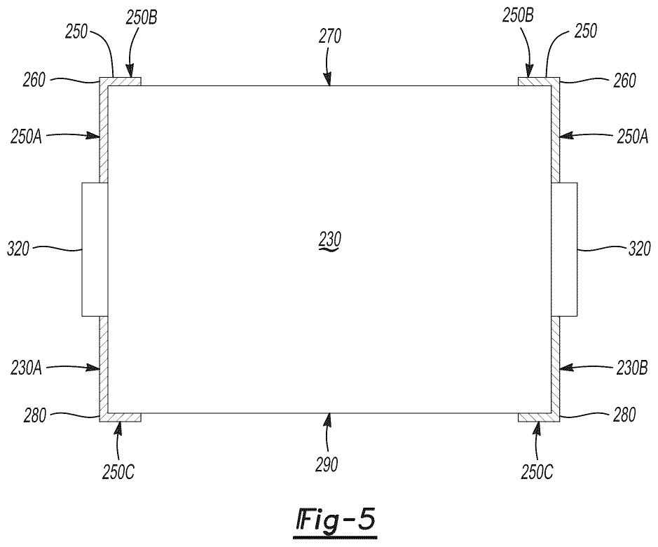

A sectional side view of one of the plurality of battery cells 230 is schematically illustrated in FIG. 4. The battery cell 230 includes structural ICB assemblies 250 disposed on opposing sides 230A, 230B of the battery cell 230.

Each of the structural ICB assemblies 250 includes a carrier having a main portion 250A that extends along the opposing sides 230A, 230B of the battery cell 230, a first end portion 250B that extends perpendicularly from a first end 260 of the main portion 250A along a top surface 270 of the battery cell 230, and a second end portion 250C that extends perpendicularly from a second end 280 of the main portion 250A along a bottom surface 290 of the battery cell 230.

According to one aspect of the disclosure, the main portions 250A of the structural ICB assemblies 250 are disposed adjacent to the opposing sides 230A, 230B of the battery cell 230.

Referring back to FIG. 3, each of the plurality of battery submodules 195 is adjacent to another of the plurality of battery submodules 195, and the structural ICB assemblies 250 from adjacent battery submodules 195 are configured to connect the adjacent battery submodules 195 to one another.

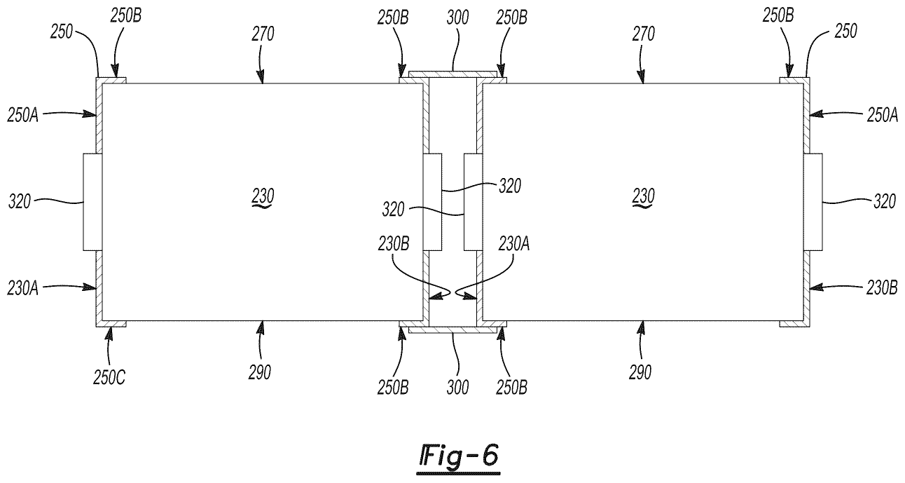

As schematically illustrated in FIG. 5, a connection 300 formed between the structural ICB assemblies 250 of the adjacent submodules 195 include an I-beam configuration.

According to one aspect of the disclosure, channels 310 are formed between the adjacent battery submodules 195 when the structural ICB assemblies 250 of the adjacent battery submodules 1905 are connected to one another. The channels 310 can be used to assist in controlling the flow of cell off-gassing.

Each battery cell 230 includes a cell tab 320 extending outward from the opposing sides 230A, 230B of the battery cell 230. The structural ICB assemblies 250 are also disposed on the opposing sides 230A, 230B of the battery cell 230. Each cell tab 320 includes one of a positive terminal and a negative terminal, with each battery cell 230 including one positive terminal and one negative terminal.

Adhesive strip(s) (not shown) may be disposed underneath each structural ICB assembly to provide additional stiffness. The adhesive strip(s) are disposed between the structural ICB assembly 250 and the battery cell 230.

According to one aspect of the disclosure, at least a subset of the cell tabs 320 is attached to busbars (not shown). The subset of the cell tabs 320 may be attached to the busbars (not shown) via welding.

According to another aspect of the disclosure, a modular energy storage system 100 is also disclosed. The modular energy storage system 100 includes at least two energy storage enclosures 110 coupled to one another, a power conversion module 120 coupled to an external power source 150 and the at least two energy storage enclosures 110.

Each of the at least two energy storage enclosures 110 includes a battery pack 180, a plurality of battery modules 190 disposed within the battery back, a plurality of submodules 195 disposed within each of the plurality of battery modules 190, and a plurality of cells 230 disposed within each of the battery submodules 195.

According to one aspect of the disclosure, each battery cell 230 includes structural interconnect board (ICB) assemblies 250 disposed on opposing sides 230A, 230B of the battery cell 230.

Each of the structural ICB assemblies 250 includes a carrier having a main portion 250A that extends along one of the opposing sides 253A, 253B of the battery cell 230, a first end portion 250B that extends perpendicularly from a first end 260 of the main portion 250A along a top surface 270 of the battery cell 230, and a second end portion 250C that extends perpendicularly from a second end 280 of the main portion 250A along a bottom end 290 of the battery cell 230.

Referring back to FIG. 3-FIG. 6, according to another aspect of the disclosure, a battery module 190 for an energy storage enclosure is also disclosed. The battery module 190 includes a bottom plate 200, a cooling plate 210, a thermal interface layer 220, a plurality of battery submodules 195 including a plurality of battery cells 230 disposed adjacent to one another, and a battery module enclosure 240.

The plurality of battery submodules 195 are disposed within the battery module 190, and a subset of the plurality of battery cells 230 are disposed within each of the battery submodules 195.

A battery cell 230 includes structural ICB assemblies 250 disposed on opposing sides 230A, 230B of the battery cell 230 (FIG. 4).

Each of the structural ICB assemblies 250 includes a carrier having a main portion 250A that extends along the opposing sides 230A, 230B of the battery cell 230, a first end portion 250B that extends perpendicularly from a first end 260 of the main portion 250A along a top surface 270 of the battery cell 230, and a second end portion 250C that extends perpendicularly from a second end 280 of the main portion 250A along a bottom surface 290 of the battery cell 230.

According to one aspect of the disclosure, the main portions 250A of the structural ICB assemblies 250 are disposed adjacent to the opposing sides 230A, 230B of the battery cell 230.

Each of the plurality of battery submodules 195 is adjacent to another of the plurality of battery submodules 195, and the structural ICB assemblies 250 from adjacent battery submodules 195 are configured to connect the adjacent battery submodules 195 to one another (FIG. 3).

A connection 300 formed between the structural ICB assemblies 250 of the adjacent submodules 195 include an I-beam configuration (FIG. 5).

According to one aspect of the disclosure, channels 310 are formed between the adjacent battery submodules 195 when the structural ICB assemblies 250 of the adjacent battery submodules 1905 are connected to one another. The channels 310 can be used to assist in controlling the flow of cell off-gassing.

Each battery cell 230 includes a cell tab 320 extending outward from the opposing sides 230A, 230B of the battery cell 230. The structural ICB assemblies 250 are also disposed on the opposing sides 230A, 230B of the battery cell 230. Each cell tab 320 includes one of a positive terminal and a negative terminal, with each battery cell 230 including one positive terminal and one negative terminal.

Adhesive strip(s) (not shown) may be disposed underneath each structural ICB assembly to provide additional stiffness. The adhesive strip(s) are disposed between the structural ICB assembly 250 and the battery cell 230.

According to one aspect of the disclosure, at least a subset of the cell tabs 320 is attached to busbars (not shown). The subset of the cell tabs 320 may be attached to the busbars (not shown) via welding.

By providing structural ICB assemblies 250, stiffness of the battery cells/cell stack can be increased, which allows for longer submodules and/or cell stacks to be utilized. In turn, storage capacity of each battery submodule 195 is increased, allowing for more energy dense battery modules 190.

By providing structural ICB assemblies 250 including carriers that wrap around the edges of each individual battery cell 230, stiffness of the battery cell/cell stack is increased resulting in increased structural support.

Sensing and bussing may be incorporated with the increased structural support, which reduces component complexity and assembly time. The incorporation of sensing and bussing with increased structural support may be used to optimize the cell to cold plate gap by reducing component complexity.

By utilizing the structural ICB assemblies 250 to connect battery submodules 195 to one another in an I-beam configuration, channels 310 for gases may be created to assist in controlling the flow of cell off-gassing.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. An energy storage enclosure comprising:
a battery pack;
a plurality of battery modules disposed within the battery pack;
a plurality of battery submodules disposed within each of the plurality of battery modules;
a plurality of battery cells disposed within each of the plurality of battery submodules, wherein each of the plurality of battery cells includes structural interconnect board (ICB) assemblies disposed on opposing sides of each of the plurality of battery cells,
wherein each of the structural ICB assemblies includes a carrier having:
a main portion that extends along one of the opposing sides of the battery cell;
a first end portion that extends perpendicularly from a first end of the main portion along a top surface of the battery cell; and
a second end portion that extends perpendicularly from a second end of the main portion along a bottom end of the battery cell.

2. The energy storage enclosure as recited in claim 1, wherein each battery cell includes a cell tab extending outward from the opposing sides of the battery cell, and wherein the structural ICB assemblies are disposed on the opposing sides of the battery cell.

3. The energy storage enclosure as recited in claim 2, wherein the cell tab includes one of a positive terminal and a negative terminal.

4. The energy storage enclosure as recited in claim 2, wherein the main portions of the structural ICB assemblies are disposed adjacent to the opposing sides of the battery cell.

5. The energy storage enclosure as recited in claim 4, wherein each of the plurality of battery submodules is adjacent to another of the plurality of battery submodules, and the structural ICB assemblies from adjacent battery submodules are configured to connect the adjacent battery submodules to one another.

6. The energy storage enclosure as recited in claim 5, wherein the connection between the structural ICB assemblies of the adjacent battery submodules includes an I-beam configuration.

7. The energy storage enclosure as recited in claim 6, wherein channels are formed between the adjacent battery submodules when the structural ICB assemblies of the adjacent battery submodules are connected to one another.

8. The energy storage enclosure as recited in claim 7, wherein at least a subset of the cell tabs is attached to busbars.

9. The energy storage enclosure as recited in claim 8, wherein the subset of the cell tabs is attached to the busbars via welding.

10. The energy storage enclosure as recited in claim 1, including adhesive strips between the structural ICB assemblies and battery cell.

11. A modular energy storage system comprising:
at least two energy storage enclosures coupled to one another;
a power conversion module coupled to an external power source and the at least two energy storage enclosures, wherein each of the at least two energy storage enclosures includes:
a battery pack;
a plurality of battery modules disposed within the battery pack;
a plurality of battery submodules disposed within each of the plurality of battery modules;
a plurality of battery cells disposed within each of the plurality of battery submodules, wherein each of the plurality of battery cells includes structural interconnect board (ICB) assemblies disposed on opposing sides of each of the plurality battery cells,
wherein each of the structural ICB assemblies includes a carrier having:
a main portion that extends along one of the opposing sides of the battery cell;
a first end portion that extends perpendicularly from a first end of the main portion along a top surface of the battery cell; and
a second end portion that extends perpendicularly from a second end of the main portion along a bottom end of the battery cell.

12. A battery module for an energy storage enclosure, the battery module comprising:
a plurality of battery submodules arranged within the battery module; and
a plurality of battery cells arranged within each of the plurality of battery submodules, wherein each of the plurality of battery cells includes structural interconnect board (ICB) assemblies disposed on opposing sides of each of the plurality of battery cells, each of the structural ICB assemblies includes a carrier having:
a main portion that extends along one of the opposing sides of the battery cell;
a first end portion that extends perpendicularly from a first end of the main portion along a top surface of the battery cell; and
a second end portion that extends perpendicularly from a second end of the main portion along a bottom end of the battery cell.

13. The battery module as recited in claim 12, wherein each of the plurality of battery cells includes a cell tab extending outward from the opposing sides of the battery cell, and wherein the structural ICB assemblies are disposed on the opposing sides of the battery cell.

14. The battery module as recited in claim 13, wherein the cell tab includes one of a positive terminal and a negative terminal.

15. The battery module as recited in claim 13, wherein at least a subset of the cell tabs is attached to busbars via welding.

16. The battery module as recited in claim 12, wherein the main portions of the structural ICB assemblies are disposed adjacent to the opposing sides of the battery cell.

17. The battery module as recited in claim 12, wherein each of the plurality of battery submodules is adjacent to another of the plurality of battery submodules, and the structural ICB assemblies from adjacent battery submodules are configured to connect the adjacent battery submodules to one another.

18. The battery module as recited in claim 17, wherein the connection between the structural ICB assemblies of the adjacent battery submodules includes an I-beam configuration.

19. The battery module as recited in claim 17, wherein channels are formed between the adjacent battery submodules when the structural ICB assemblies of the adjacent battery submodules are connected to one another.

20. The battery module as recited in claim 12, including adhesive strips between the structural ICB assemblies and battery cell.
